(19) United States
(12) Patent Application Publication
(10) Pub. No.: US 2010/0319266 A1
(43) Pub. Date: Dec. 23, 2010

(54) HINGES

(76) Inventor: John Dawson, Auckland (NZ)

Correspondence Address: JACOBSON HOLMAN PLLC, 400 SEVENTH STREET N.W., SUITE 600, WASHINGTON, DC, 20004, US

(21) Appl. No.: 12/734,631

(22) PCT Filed: Oct. 9, 2008
(86) PCT No.: PCT/NZ2008/000264

§ 371 Date: Aug. 25, 2010

(30) Foreign Application Priority Data
Nov. 13, 2007 (NZ) 563386

(51) Int. Cl. E05D 15/00; E05D 5/02; E05D 3/02; E06B 3/34

(52) U.S. Cl. 49/399; 16/384; 49/507

(57) ABSTRACT

A hinge set (and associated methodology and resultant hung doors or windows) where the leaf of each hinge sleeved component is, or is to be, leafwise received in, and is, or to be, screwed into, a different cavity, yet allowing aligned sleeve meshing for pin insertion. Its use allows the leaf to be largely concealed even when the doors or windows are open.

The present invention relates to hinges.

Many different forms of hinge are known whereby one or more hinges can be used in order to articulate a member from another, by way of example, to articulate a door from a door jamb, to articulate a window from a window jamb or frame, etc.

The present invention relates to such hinges as well as hinges having other application.

A common type of hinge used for mounting doors or windows are so-called leaf hinges that have two main components each of a leaf and at lest one sleeve to receive the hinge pin, each engageable to the jamb or frame or the door and window by the use of penetrative fixers (such as screws) that pass normally through openings of the leaf. The one or more sleeve of each component is to align with the sleeve axis of a corresponding sleeve or sleeves of the other component, thereby to receive axially of the aligned sleeve axes, a hinge pin that provides the necessary articulation or pivot axis.

The present invention relates to an has an object hinges, members to associate therewith, etc whereby the hinge, when fitted in use, will be at least largely concealed, at least both when the door or window is open and when both the door and window is shut, save for the aligned sleeves and the hinge pin.

It is an object of the present invention to provide components of a hinge, a subassembly or assembly of such components to provide a hinge or sub assembly thereof, a hinge, a hinge kit, a hinged mounting of a member to articulate one relative to another, members to receive such hinge components, etc or to at least provide the public with a useful choice.

In an aspect the invention is a hinge assembly or a kit therefor comprising or including

a first component being a leaf carrying at least one sleeve,

a second component being a leaf carrying at least one sleeve, the second component being a complement to the first component, and

a hinge pin through the sleeves or fittable through said sleeves when aligned,

wherein at least one leaf is substantially plate-like (skeletal or not) with an actual or notional general plate plane and has at least one passageway therethrough coincident with and/or parallel to said general plate plane (notional or otherwise) for a fixing screw,

and wherein the axis (or axes) of such leaf passageway(s) is (are) offset from, but is (or are) substantially normal to, the or each leafs sleeve axis,

and wherein each general plate plane is at least substantially parallel to its leafs sleeve axis.

Preferably both a first and second component has more than one sleeve. Preferably at least one (and preferably both) components has (have) a leaf carrying two sleeves.

Preferably the offset of each plate plane general axis from its sleeve(s) is substantially the same, but complementary, thereby enabling hinge pin insertion through the sleeves of both components when complementing each other.

In another aspect the invention is a hinge assembly or a kit therefor comprising or including

a first component being a leaf carrying at least one sleeve,

a second component being a leaf carrying at least one sleeve, the second component being a complement to the first component, and

a hinge pin through the sleeves or fittable through said sleeves when aligned;

wherein both components can have its leaf located in a routed cavity of a jamb, frame, door and/or window,

and wherein each leaf is offset from its sleeve axis;

and wherein in use each leaf can extend into a said cavity at about 45° so that, in a closed condition, the two leafs are separated by about 90°.

Preferably both a first and second component has more than one sleeve.

Preferably at least one (and preferably both) components has (have) a leaf carrying two sleeves.

In an aspect the invention consists in a hinged assembly of one member (eg, a door or window) relative to another member (a door jamb, window frame or jamb, etc.) reliant on a hinge assembly of two components and a hinge pin,

wherein each of said members has a routed or other receiving opening or cavity therein carrying a leaf of said component.

Preferably each component has a leaf and a retained in such an opening or cavity by a screw passing through the leaf.

In an aspect the invention is a hung door or window where its hinge, or hinges, has, or each has, a hinge leaf retained at about 45° (eg, plus or minus 10°) to the closed door or window.

The invention also consists in a method of hinging one member to another, said method comprising the steps of
(i) fixing a leafed sleeve component of a hinge by its leaf in a cavity of a first member,
(ii) fixing a leafed sleeve component of a hinge by its leaf in a cavity of the second member, and
(iii) before or after step (ii) aligning the sleeves and inserting a hinge pin.

Preferably at least one of steps (i) and (ii) involves edgewise insertion into a door or window at about 45°.

Preferably both step (i) and (ii), or one of them, involves inserting at least one screw in and through the leaf of the component. In less preferred forms the leaf itself can be self retaining and/or adhered in a said cavity.

Preferably the hinge is a hinge assembly or hinge kit or combination of parts of the present invention.

The present invention also relates to a component or components of a hinge of any of the kinds herein described with reference to any one or more of the accompanying drawings.

The present invention also consists in a member to support the hinge and/or to support the hinged member which has a leaf receiving cavity substantially as herein described with reference to any one or more of the accompanying drawings.

In yet a further aspect, the invention consists in a method of hinging which involves the use of the present invention in a manner substantially as herein described with reference to any one or more of the accompanying drawings.

In still a further aspect, the invention consists in a hinge assembly, irrespective of the number of sleeves on each component, but provided they are compatible, substantially as herein described with reference to any one or more of the accompanying drawings.

A preferred form of the present invention will now be described with reference with the accompanying drawings in which

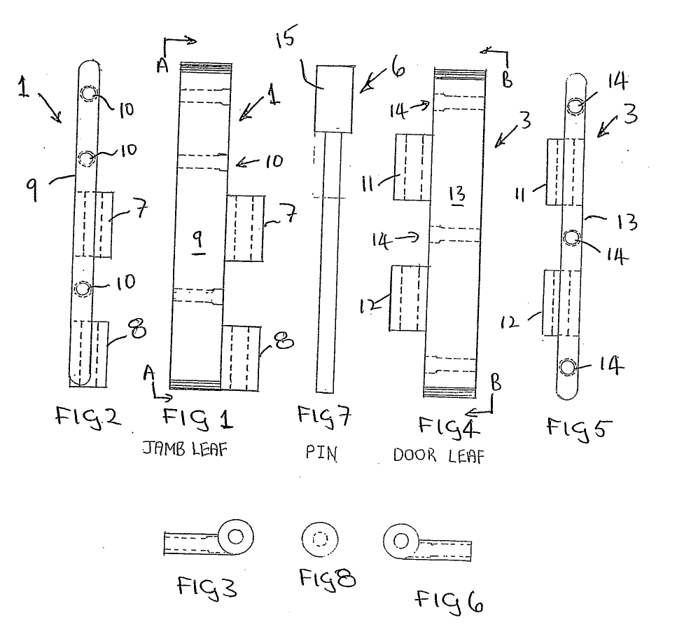

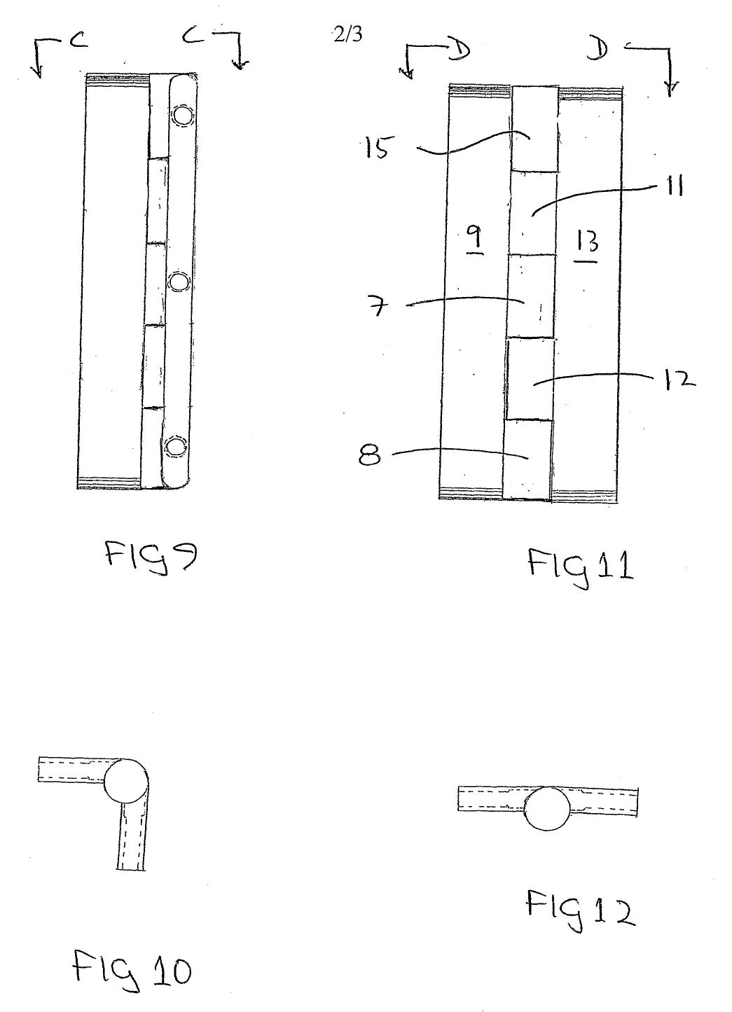

FIG. 1 is a side elevational view of a first component of a hinge in accordance with the present invention, such component to 2 sleeves in alignment from a non-skeletal leaf which has in the leaf fitting passageways to receive an appropriately configured screw,

FIG. 2 is a view AA of the component of FIG. 1,

FIG. 3 is a bottom view of the component of FIGS. 1 and 2,

FIG. 4 shows the complimentary component to that of FIGS. 1 to 3, such component again having a leaf with fitting passageways in the leaf (but not normal to the general plane or planes of the leaf) and also carrying two sleeves, such sleeves being able to mesh with those of the component of FIGS. 1 to 3.

FIG. 5 is a view BB of the component of FIG. 4,

FIG. 6 is a view from below of the component of FIGS. 4 and 5,

FIG. 7 is an elevational view of a hinge pin having a head region to match the outer circumference of the sleeves of the components of FIGS. 1 to 3 and 4 to 6,

FIG. 87 is a top view of the hinge pin of FIG. 7,

FIG. 9 is an assembly of the components of FIGS. 1 to 7 in one mode to a component of FIG. 5,

FIG. 10 is a view CC of the assembly of FIG. 9,

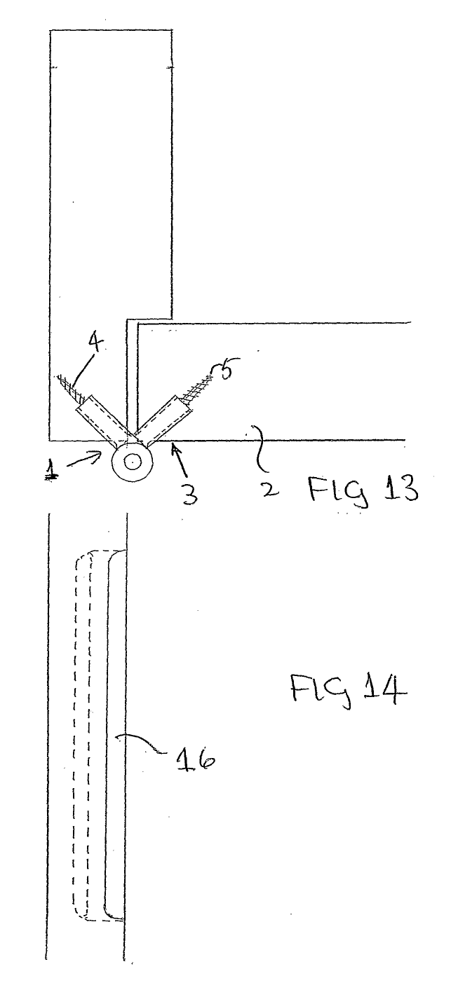

FIG. 11 is the same component as in FIGS. 9 and 10 but with the general planes of the first and second component substantially aligned,

FIG. 12 is a view DD of the assembly of FIG. 11,

FIG. 13 is a diagrammatic view of a door or window jamb and a closed door or window with the assembly as in FIGS. 9 and 10 having the leaf of each of the two components received edgewise within a routed cavity of each of the jamb and door/window respectively and fixed thereto by penetrative fasteners (eg, screws) passing into, through and beyond the respective passageways of each of the first and second components, and

FIG. 14 shows a routed recess and its extent when viewed in elevation.

Hinges of the present invention are preferably made by machining the first and second components from an extruded member. Alternatively, the overall hinge can be moulded or otherwise made. The hinge pin preferably is turned or moulded or press formed.

Suitable materials include metals such as steel, brass, aluminium and the like. For some uses, extruded aluminium members may be machined to provide the first and second component. Likewise the hinge pin although, if desired the hinge pin can be of a dissimilar material. Moreover, if desired, each of the first and second components can be of a different material.

A routed cavity 16, preferably at about 45° is shown in FIGS. 13 and 14. It is provided to receive, for a first component 1, most of the leaf region thereof. Likewise a 45° or thereabouts cavity in the door 2 to receive the leaf of the second component 3. A shown a hinge pin can hold the aligned and interposing sleeves of components 1 and 3 in register to allow pivoting one relative to the other.

Shown in FIG. 13 are the screws 4 of the first component 1 and the screws 5 of the second component 3.

Preferably the view is not as in FIGS. 9 and 10 but rather has one of the leafs rotated by 180° from that condition so that it is essentially only the revealed regions of the hinge pin 6 and the aligned sleeves that can be seen. See FIG. 13 in this respect.

Shown in FIG. 1 are sleeves 7 and 8, the leaf 9 and the screw receiving passageways 10.

Likewise for the component 3, there are sleeves 11 and 12, the leaf 13 and screw receiving passageways 14. The head 15 of the hinge pin 6 can be seen as if were part of the sleeve sequence.

For heavy applications, or as an alternative method of fixing, it is possible to insert an insert nut in the bottom of the routered cavity for the purpose of using machine screws for fixing.

If desired a hex head screw can be used for fixing, making it easier to engage the head of the screw in the countersunk portion of the leaf, as a standard Phillips or Pozi Drive screw head of the size required would be difficult to get the degree of fixing without wearing or stripping the screw head.

In manufacture from certain materials, there can be the insertion of a nylon or plastic sleeve inside the sleeve for the hinge pin to reduce friction on the hinge pin, and the insertion of a nylon or plastic load bearing material between the sleeve (“knuckles”) to act as a washer. This is desirable in aluminium hinges.

A suitable fitting sequence is to jig machine router appropriate cavities in the jamb joinery and the door and/or window. Thereafter the components 1 and 3 can each be fitted and prior to hinge pinning of the components one to the other.

1. A hinge assembly or a kit therefor comprising or including
a first component being a leaf carrying at least one sleeve,
a second component being a leaf carrying at least one sleeve, the second component being a complement to the first component, and
a hinge pin through the sleeves or fittable through said sleeves when aligned,
wherein at least one leaf is substantially plate-like (skeletal or not) with an actual or notional general plate plane and has at least one passageway therethrough coincident with and/or parallel to said general plate plane (notional or otherwise) for a fixing screw,
and wherein the axis (or axes) of such leaf passageway(s) is (are) offset from, but is (or are) substantially normal to, the or each leaf's sleeve axis,
and wherein each general plate plane is at least substantially parallel to its leaf's sleeve axis.

2. The apparatus of claim 1 wherein both the first and second component has more than one sleeve.

3. The apparatus of claim 2 wherein at least one components has a leaf carrying two sleeves.

4. The apparatus of claim 3 wherein both components has at least two sleeves.

5. The apparatus of claim 1 wherein the offset of each plate plane general axis from its sleeve(s) is substantially the same, but complementary, thereby enabling hinge pin insertion through the sleeves of both components when complementing each other.

6. A hinge assembly or a kit therefor comprising or including
a first component being a leaf carrying at least one sleeve,
a second component being a leaf carrying at least one sleeve, the second component being a complement to the first component, and
a hinge pin through the sleeves or fittable through said sleeves when aligned,
wherein both components can have its leaf located in a routed cavity of a jamb, frame, door and/or window,
and wherein each leaf is offset from its sleeve axis,
and wherein in use each leaf can extend into a said cavity at about 45° so that, in a closed condition, the two leafs are separated by about 90°.

7. The apparatus of claim 6 wherein both the first and second component has more than one sleeve.

8. The apparatus of claim 7 wherein at least one component has a leaf carrying two sleeves.

9. The apparatus of claim 8 wherein both components as at least two sleeves.

10. A hinged assembly of one member (eg, a door or window) relative to another member (a door jamb, window frame or jamb, etc.) reliant on a hinge assembly of two components and a hinge pin,
wherein each of said members has a routed or other receiving opening or cavity therein carrying a leaf of said component.

11. The assembly of claim 10 wherein each component has a leaf and a retained in such an opening or cavity by a screw passing through the leaf.

12. A hung door or window where its hinge, or hinges, has, or each has, a hinge leaf retained at about 45° to the closed door or window.

13. A method of hinging one member to another, said method comprising the steps of:
(i) fixing a leafed sleeve component of a hinge by its leaf in a cavity of a first member,
(ii) fixing a leafed sleeve component of a hinge by its leaf in a cavity of the second member, and
(iii) before or after step (ii), aligning the sleeves and inserting a hinge pin.

14. The method of claim 13 wherein at least one of steps (i) and (ii) involves edgewise insertion into a door or window at about 45°.

15. The method of claim 13 wherein both step (i) and (ii) or one of them, involves inserting at least one screw in and through the leaf of the component.

16. The method of claim 13 wherein at least one leaf is self retaining and/or adhered in its said cavity.

17. The method of hinging one member to another, said method comprising the steps of:
(iv) fixing a leafed sleeve component of a hinge by its leaf in a cavity of a first member,
(v) fixing a leafed sleeve component of a hinge by its leaf in a cavity of the second member, and
before or after step (ii), aligning the sleeves and inserting a hinge pin that uses a kit of claim 1 or that results in hinge assembly of claim 1.

18. (canceled)

19. (canceled)

20. (canceled)

21. (canceled)
